(19) United States
(12) Patent Application Publication
(10) Pub. No.: US 2023/0318095 A1
(43) Pub. Date: Oct. 5, 2023

(54) SECONDARY BATTERY

(71) Applicant: SK ON CO., LTD., Seoul (KR)

(72) Inventor: Kyung Tae PARK, Daejeon (KR)

(21) Appl. No.: 18/190,122

(22) Filed: Mar. 27, 2023

(30) Foreign Application Priority Data
Mar. 31, 2022 (KR) 10-2022-0040294

(51) Int. Cl. H01M 50/105; H01M 10/653; H01M 10/0585

(52) U.S. Cl. CPC H01M 50/105; H01M 10/653; H01M 10/0585

(57) ABSTRACT

A secondary battery includes an electrode assembly, a pouch accommodating the electrode assembly, and an insulating element formed on an inner surface of the pouch. An inside of the pouch includes an accommodating portion for inserting the electrode assembly and peripheral portions around the accommodating portion. At least one of the peripheral portions has a sealing surface and a non-sealing surface. The insulating element is formed on the non-sealing surface and is not formed on the sealing surface.

### CROSS-REFERENCE TO RELATED APPLICATION

This application claims priority to Korean Patent Application No. 10-2022-0040294 filed on Mar. 31, 2022 in the Korean Intellectual Property Office (KIPO), the entire disclosure of which is incorporated by reference herein.

### BACKGROUND

### 1. Field

The present invention relates to a secondary battery. More particularly, the present invention relates to a secondary battery including an electrode assembly and a pouch.

### 2. Description of the Related Art

A secondary battery which can be charged and discharged repeatedly has been widely employed as a power source of a mobile electronic device such as a camcorder, a mobile phone, a laptop computer, etc., according to developments of information and display technologies. Recently, a battery pack including the secondary battery is being developed and applied as an eco-friendly power source of an electric automobile, a hybrid vehicle, etc.

Examples of the secondary battery includes a lithium secondary battery, a nickel-cadmium battery, a nickel-hydrogen battery, etc. The lithium secondary battery is widely developed and applied due to high operational voltage and energy density per unit weight, a high charging rate, a compact dimension, etc.

For example, the secondary battery may include an electrode assembly including a cathode, an anode and a separation layer (separator), and an electrolyte immersing the electrode assembly. The secondary battery may further include an outer case having, e.g., a pouch shape for accommodating the electrode assembly and the electrolyte.

The outer case includes a substrate layer for sealing after accommodating the electrode assembly, a metal layer, an adhesive layer for bonding the substrate layer and the metal layer, etc.

For example, as an application range of lithium secondary batteries is expanding, a nickel content of a cathode active material becomes greater for enhancing high-capacity property. When the nickel content is increased, a gas at an inside of the pouch may be increased and an internal pressure increases at high temperature. Accordingly, a sealing of the pouch may be delaminated or damaged.

Thus, an enhanced pouch sealing may be required to secure high-temperature stability of the battery. However, if a sealing temperature or a sealing time is increased to obtain an enhanced sealing strength of the pouch, the substrate layer of the pouch may be melted in a portion other than a sealing portion, and a spot welding may occur in the pouch. Further, instability of the battery may be caused by an electrolyte leakage and corrosion.

### SUMMARY

According to an aspect of the present invention, there is provided a secondary battery having improved stability and pressure resistance.

A secondary battery includes an electrode assembly, a pouch accommodating the electrode assembly, and an insulating element formed on an inner surface of the pouch. An inside of the pouch includes an accommodating portion for inserting the electrode assembly and peripheral portions around the accommodating portion. At least one of the peripheral portions has a sealing surface and a non-sealing surface, and the insulating element is formed on the non-sealing surface and is not formed on the sealing surface.

In some embodiments, the insulating element may be formed within 10 mm from a boundary between the sealing surface and the non-sealing surface.

In some embodiments, the insulating element may be formed within 0.1 mm to 5 mm from a boundary between the sealing surface and the non-sealing surface.

In some embodiments, an electrode tab may be connected to the electrode assembly and drawn to the peripheral portion of the pouch. The peripheral portions may include a tab drawing portion through which the electrode tab may be drawn out and a side peripheral portion from which the electrode tab may not be drawn out.

In some embodiments, the insulating element may be formed on at least a portion of an inner surface of the tab drawing portion and an inner surface of the side peripheral portion.

In some embodiments, the tab drawing portion may be formed at upper and lower sides of the pouch, and the side peripheral portion may be connected to the upper and lower sides.

In some embodiments, the tab drawing portion may be formed at an upper side or a lower side of the pouch, and the side peripheral portion may be connected to the upper side or the lower side.

In some embodiments, the accommodating portion may include a first accommodating portion and a second accommodating portion facing each other, and the peripheral portions may further include a folding portion separating the first accommodating portion and the second accommodating portion.

In some embodiments, the insulating element may not be formed on an inner surface of the folding portion.

In some embodiments, the insulating element may include an insulating tape including at least one selected from the group consisting of polyethylene, polyacetylene, polytetrafluoroethylene, nylon, polyimide, polyethylene terephthalate, polypropylene and chlorinated polypropylene.

In some embodiments, the pouch may have a laminated structure including a sealant layer, a metal layer and a coating layer.

In some embodiments, the sealant layer may include a polyolefin-based resin, the metal layer may include aluminum, and the coating layer may include nylon.

According to embodiments of the present invention, an insulating element is formed on a non-sealing surface of a peripheral portion of a pouch for a secondary battery to prevent a spot welding of the pouch that may occur in a sealing process during a battery fabrication. The spot welding may be suppressed, so that sealing conditions may be further strengthened, and thus a pressure resistance of the pouch can be enhanced.

In some embodiments, the insulating element is formed on the non-sealing surface of the peripheral portion of the pouch, so that the spot welding may be effectively prevented in the sealing process without an additional introduction or modification of a tool or an equipment.

### BRIEF DESCRIPTION OF THE DRAWINGS

FIG. 1 is a schematic plan view illustrating a lithium secondary battery in accordance with exemplary embodiments.

FIG. 2 is a partially enlarged plan view illustrating a peripheral portion of a secondary battery pouch in accordance with exemplary embodiments.

FIG. 3 is a schematic plan view illustrating a secondary battery in accordance with exemplary embodiments.

FIG. 4 is a cross-sectional view taken along a line I-I′ of FIG. 3.

FIG. 5 is a cross-sectional view illustrating a laminated structure of a pouch of a secondary battery in accordance with exemplary embodiments.

### DETAILED DESCRIPTION OF THE EMBODIMENTS

Hereinafter, embodiments of the present invention will be described in detail with reference to embodiments and examples, and the accompanying drawings. However, those skilled in the art will appreciate that such embodiments and drawings are provided to further understand the spirit of the present invention and do not limit subject matters to be protected as disclosed in the detailed description and appended claims.

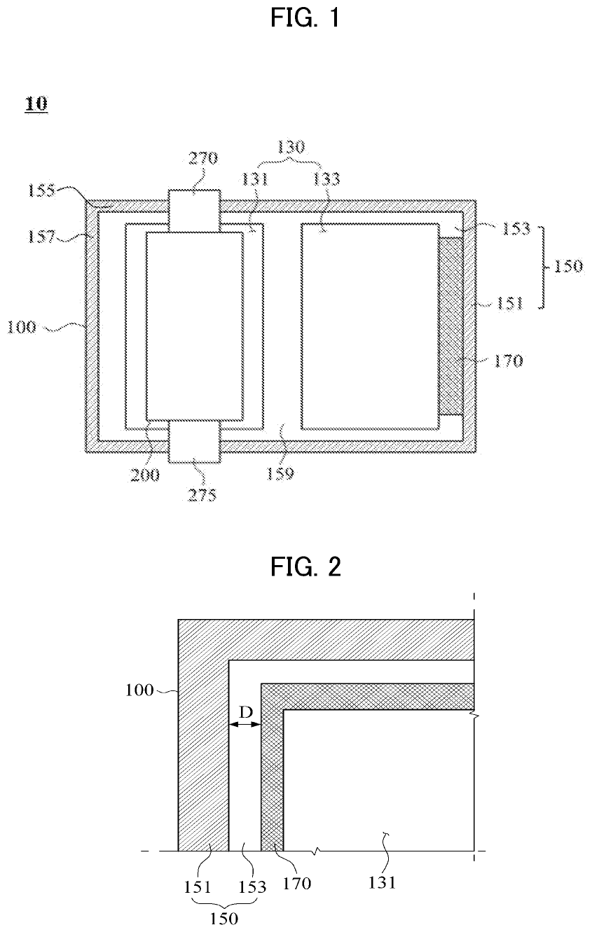

FIG. 1 is a schematic plan view illustrating a lithium secondary battery in accordance with exemplary embodiments. For convenience of descriptions, a pouch 100 is shown in a non-folded state in FIG. 1.

An inner surface (an inner surface in a folded state) of the pouch 100 may include an accommodating portion 130 for inserting or housing an electrode assembly 200 and a 20 peripheral portion 150 around the accommodating portion 130. The peripheral portion 150 may include a sealing surface 151 and a non-sealing surface 153.

The sealing surface 151 refers to a surface to be sealed by a contact/pressing of a sealing jig in a sealing process during a battery fabrication. The non-sealing surface 153 refers to a portion that the sealing jig does not contact/press in the sealing process. As will be described later, the non-sealing surface 153 may include a portion where the insulating element 170 may be formed.

In an embodiment, the peripheral portion 150 refers to an area surrounding the accommodating portion 130 for inserting or housing the electrode assembly 200. The peripheral portion 150 may include a tab drawing portion 155 formed at a region where electrode tabs 270 and 275 are drawn out and a side peripheral portion 157 formed at a region where the electrode tabs 270 and 275 are not drawn out.

For example, the first electrode tab 270 and the second electrode tab 275 may be formed at both sides which are upper and lower sides of the electrode assembly 200 in a plan view of FIG. 1. The first electrode tab 270 and the second electrode tab 275 may protrude to an outside through the tab drawing portions 155 formed at the upper and lower sides of the pouch 100.

In an embodiment, both the first electrode tab 270 and the second electrode tab 275 may be formed at one side (the upper side or the lower side) of the electrode assembly 200, and the first electrode tab 270 and the second electrode tab 275 may protrude to the outside through the tab drawing portion 155 formed at the upper side or the lower side of the pouch 100.

In an embodiment, the accommodating portion 130 may have a recess shape being pressed or concave to a predetermined depth from the peripheral portion 130. The electrode assembly 200 may be disposed in the accommodating portion 130. A size and a shape of the accommodating portion 130 may be adjusted according to a size and a shape of the electrode assembly 200.

The accommodating portion 130 may be divided into a first accommodating portion 131 and a second accommodating portion 133 by a folding portion 159. The first accommodating portion 131 may accommodate a lower portion of the electrode assembly 200, and the second accommodating portion 133 may cover an upper portion of the electrode assembly 200. In some embodiments, the lower portion of the electrode assembly 200 may be inserted in the second accommodating portion 133, and the first accommodating portion 131 may cover the upper portion of the electrode assembly 200.

A structure and a shape of the folding portion 159 are not particularly limited, and may include a protrusion or may have a flat shape.

The electrode assembly 200 may be seated in either of the first accommodating portion 131 or the second accommodating portion 133, and the other one of the first accommodating portion 131 or the second accommodating portion 133 may be folded along the folding portion 159. Accordingly, the electrode assembly 200 may be surrounded or wrapped by the pouch 100.

In this case, the first accommodating portion 131 and the second accommodating portion 133 may face each other, and the peripheral portion of the first accommodating portion 110 and the peripheral portion of the second accommodating portion 133 may also face each other and contact each other.

Compression or fusion may be performed along edges of the peripheral portions facing and contacting each other using a sealing jig to form the sealing surface 151. The non-sealing surface 153 may be defined along inner sides of the sealing surface 151. The non-sealing surface 151 may be a region which is not directly compressed or fused by the sealing jig.

In an embodiment, the insulating element 170 may be formed on the non-sealing surface 153, and the insulating element may not be formed on the sealing surface 151.

For example, the insulating element 170 may be formed by attaching an insulation tape. In a preferable embodiment, the insulation tape may be attached on the non-sealing surface 153 before being pressed by the sealing jig to form the insulating element 170. Thereafter, the compression or the fusion may be performed on the sealing surface 151 using the sealing jig, so that the electrode assembly 200 may be sealed within an inside of the pouch. The electrode tabs 270 and 275 may be sealed while protruding to an outside from the peripheral portion 150.

The sealing may be performed after the insulation tape is attached to the non-sealing surface 153, and thus a heat propagation to a region other than the sealing surface 151 can be prevented. Accordingly, the spot welding of the pouch occurring at an undesirable portion may be prevented. Thus, a risk of the spot welding may be avoided or reduced, so that sealing conditions may be further strengthened, and the pressure resistance of the pouch may be enhanced.

In an embodiment, the insulating element 170 may be formed on an inner surface of the tab drawing portion 155. In an embodiment, the insulating element 170 may be formed on an inner surface of the side peripheral portion 157. In an embodiment, the insulating element 170 may be formed along the tab drawing portion 155 and the side peripheral portion 157, and may be formed entirely along the peripheral portion 150. In a preferable embodiment, the insulating element 170 may not be formed on the folding portion 159.

For example, the sealing surface 151 may be formed at an edge of the tab drawing portion 155, and the insulating element 170 may be formed on the non-sealing surface 153 of the inner surface of the tab drawing portion 155.

For example, the sealing surface 151 may be formed at an edge of the side peripheral portion 157, and the insulating element 170 may be formed on the non-sealing surface 153 of the inner surface of the side peripheral portion 157.

For example, the sealing surface 151 may be formed at edges of the tab drawing portion 155 and the side peripheral portion 157, and the insulating element 170 may be formed on the non-sealing surface 153 of the inner surfaces included in the tab drawing portion 155 and the side peripheral portion 157.

An outer side or the sealing surface of the peripheral portion 150 does not contact the electrolyte even though the spot welding occurs in the pouch. Thus, even though the spot welding of the pouch occurs, advantageous effects of the insulation tape/insulation coating may not be implemented at the outer side or the sealing surface.

However, according to embodiments of the present invention, as illustrated in FIG. 1, the spot welding of the pouch may be prevented by forming the insulating element 170 on the inner surface of the sealing surface and then sealing the pouch.

Therefore, corrosion of a metal layer (e.g., an aluminum layer) in the pouch caused by a direct contact with an electrolyte solution due to the spot welding may be prevented. Additionally, a reduction of the insulation resistance of the pouch due to the electrolyte solution may be prevented. Further, the risk of the spot welding may be avoided or reduced, so that the sealing conditions may be further strengthened. Thus, the pressure resistance of the pouch may also be improved. Therefore, the spot welding of the pouch in the sealing process may be effectively suppressed without introducing or modifying a new mechanism/equipment.

FIG. 2 is a partially enlarged plan view illustrating a peripheral portion of a secondary battery pouch in accordance with exemplary embodiments.

Referring to FIG. 2, as described above, the peripheral portion 150 of the pouch 100 may include a sealing surface 151 and a non-sealing surface 153, and the insulating element 170 may be formed on the non-sealing surface 153.

In an embodiment, the insulating element 170 may be formed within 10 mm from a boundary between the sealing surface 151 and the non-sealing surface 153, preferably within 0.1 mm to 5 mm. In this case, during the sealing process of applying high temperature and high pressure to end portions of the pouch in the fabrication of the battery, the pouch fusion caused by a heat propagation may be prevented. Accordingly, the sealing process conditions can be strengthened without causing the spot welding. Therefore, the reduction of the insulation resistance may be prevented, and deterioration, discoloration, corrosion, decomposition, etc. of the pouch due to an electrolyte leakage may also be prevented.

A separation distance between the insulating element 170 and the sealing surface 151 is indicated as D. The separation distance D refers to a distance between the insulating element 170 and a boundary line of the sealing surface 151 and the non-sealing surface 153.

In some embodiments, the separation distance D may be 3 mm or less, preferably from 0.1 mm to 2 mm. Within the above range, the above-mentioned pouch fusion may be more effectively prevented.

The insulating element 170 may be formed of a material that has high insulation and heat resistance and may not transformed by an electrolyte solution. Further, the insulating element 170 may be formed of a material that may not be melted even when high temperature and high pressure are applied in the sealing process.

For example, the insulating element 170 may be provided as an insulation tape, and the insulation tape may include, e.g., polyethylene (PE), polyacetylene (PA), polytetrafluoroethylene (PTFE), nylon, polyimide (PI), polyethylene terephthalate (PET), polypropylene (PP), chlorinated polypropylene (CPP), etc.

A width of the insulating element 170 may be in a range from 1 mm to 10 mm, preferably 1 mm to 6 mm. In the above range, the spot welding caused by melting of a layer included in the pouch as a heat propagates to a portion other than the sealing surface in the sealing process may be more effectively suppressed.

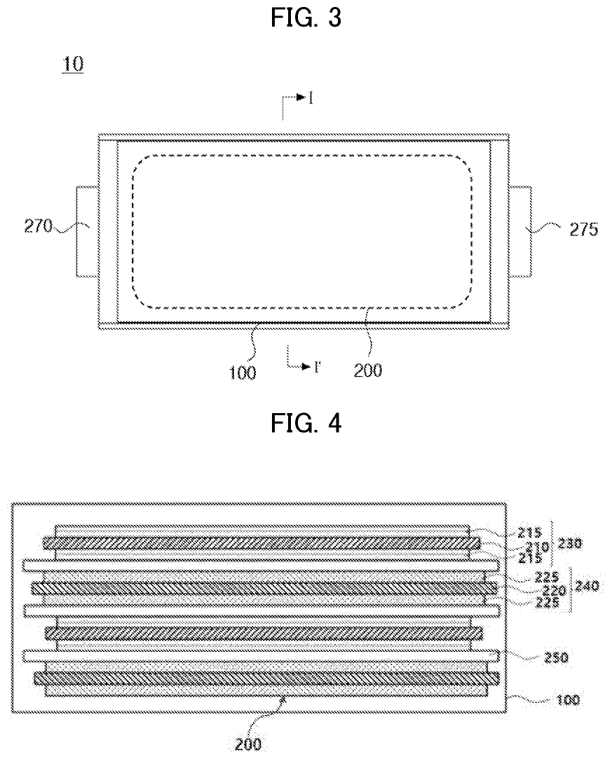

FIG. 3 is a schematic plan view illustrating a secondary battery in accordance with exemplary embodiments. FIG. 4 is a cross-sectional view taken along a line I-I′ of FIG. 3.

Referring to FIG. 4, the electrode assembly 200 may include a cathode 230, an anode 240, and a separation layer 250 interposed between the cathode 230 and the anode 240.

The cathode 230 may include a cathode current collector 210 and a cathode active material layer 215 formed by coating the cathode active material layer on the cathode current collector. The cathode active material may include a compound capable of reversibly intercalating and de-intercalating lithium ions.

The cathode 230 may be fabricated by coating a cathode slurry on the cathode current collector 210, and then drying and pressing the cathode slurry. The cathode slurry may be prepared by mixing and stirring the cathode active material with a binder, a conductive material and/or a dispersive agent in a solvent.

The cathode current collector 210 may include a metallic material that has no reactivity within a charge/discharge voltage range of the lithium secondary battery 10 and has an enhanced adhesion to the cathode active material. The cathode current collector 210 may include, e.g., stainless steel, nickel, aluminum, titanium, copper, or an alloy thereof, and may preferably include aluminum or an aluminum alloy.

The cathode active material may include lithium-transition metal composite oxide particles. For example, the lithium-transition metal composite oxide particles include nickel (Ni) and may further include at least one of cobalt (Co) and manganese (Mn).

The lithium-transition metal composite oxide particle may be represented by Chemical Formula 1 below, and the secondary battery may be a lithium secondary battery.

Li₁₊ₐNi_{1-(x+y)}CoₓM_{y}O₂ [Chemical Formula 1]

In Formula 1, −0.05≤a≤0.2, 0.01≤x≤0.3, 0.01≤y≤0.3, and M includes at least one selected from Mn, Al, Mg, Sr, Ba, B, Si, Ti, Ta, Zr and W.

Preferably, in Chemical Formula 1, 0.05≤a≤0.2, 0.01≤x≤0.2, and 0.01≤y≤0.2, and M may include at least one selected from Mn and Al.

The binder may include an organic based binder such as a polyvinylidene fluoride-hexafluoropropylene copolymer (PVDF-co-HFP), polyvinylidenefluoride (PVDF), polyacrylonitrile, polymethylmethacrylate, etc., or an aqueous based binder such as styrene-butadiene rubber (SBR) that may be used with a thickener such as carboxymethyl cellulose (CMC).

For example, a PVDF-based binder may be used as a cathode binder. In this case, an amount of the binder for forming the cathode active material layer may be reduced, and an amount of the cathode active material may be relatively increased. Thus, capacity and power of the secondary battery may be further improved.

The conductive material may be added to facilitate electron mobility between active material particles. For example, the conductive material may include a carbon-based material such as graphite, carbon black, graphene, carbon nanotube, etc., and/or a metal-based material such as tin, tin oxide, titanium oxide, a perovskite material such as LaSrCoO₃ or LaSrMnO₃, etc.

The anode 240 may include an anode current collector 220 and an anode active material layer 225 formed by coating an anode active material on a surface of the anode current collector 220.

The anode active material may include a material commonly used in the related art which may be capable of adsorbing and ejecting lithium ions. For example, a carbon-based material such as a crystalline carbon, an amorphous carbon, a carbon complex or a carbon fiber, a lithium alloy, a silicon-based material, etc.

The amorphous carbon may include a hard carbon, coke, a mesocarbon microbead (MCMB), a mesophase pitch-based carbon fiber (MPCF), etc.

The crystalline carbon may include a graphite-based material such as natural graphite, graphitized coke, graphitized MCMB, graphitized MPCF, etc.

The lithium alloy may further include aluminum, zinc, bismuth, cadmium, antimony, silicon, lead, tin, gallium, indium, etc.

The silicon-based active material may include SiOx (0<x<2) or a SiOx (0<x<2) containing a lithium compound. The SiOx containing a lithium compound may be an SiOx containing a lithium silicate. The lithium silicate may be present in at least a portion of SiOx (0<x<2) particles. For example, the lithium silicate may be present at an inside and/or on a surface of the SiOx (0<x<2) particles. The lithium silicate may include Li₂SiO₃, Li₂Si₂O₅, Li₄SiO₄, Li₄Si₃O₈, etc.

The silicon-based active material may include, a silicon-carbon composite compound such as silicon carbide (SiC).

The anode current collector 220 may include stainless steel, copper, nickel, aluminum, titanium, or an alloy thereof. Preferably, the anode current collector 220 may include copper or a copper alloy.

For example, a slurry may be prepared by mixing and stirring the anode active material with the binder, the conductive material, a thickener, etc., in a solvent. The slurry may be coated on at least one surface of the anode current collector 220, and then dried and pressed to form the anode 240 including the anode active material layer 225.

For example, the binder for the anode may include an aqueous binder such as styrene-butadiene rubber (SBR) for compatibility with the carbon-based active material, and may be used together with the thickener such as carboxymethyl cellulose (CMC).

The separation layer 250 may be interposed between the cathode 230 and the anode 240. The separation layer 250 may include a porous polymer film prepared from, e.g., a polyolefin-based polymer such as an ethylene homopolymer, a propylene homopolymer, an ethylene/butene copolymer, an ethylene/hexene copolymer, an ethylene/methacrylate copolymer, or the like. The separation layer 250 may also include a non-woven fabric formed from a glass fiber with a high melting point, a polyethylene terephthalate fiber, or the like.

In some embodiments, an area and/or a volume of the anode 240 (e.g., a contact area with the separation layer 250) may be greater than that of the cathode 230. Thus, lithium ions generated from the cathode 230 may be easily transferred to the anode 240 without a loss by, e.g., precipitation or sedimentation.

In exemplary embodiments, an electrode cell may be defined by the cathode 230, the anode 240 and the separation layer 250, and a plurality of the electrode cells may be stacked to form an electrode assembly 200 that may have e.g., a jelly roll shape. For example, the electrode assembly 150 may be formed by winding, laminating or folding of the separation layer 250.

The electrode assembly 200 may be accommodated together with an electrolyte in the pouch 100 to define the lithium secondary battery. In exemplary embodiments, a non-aqueous electrolyte may be used as the electrolyte.

The non-aqueous electrolyte may include a lithium salt and an organic solvent.

The lithium salt may be represented by Li⁺X⁻, and an anion of the lithium salt X⁻ may include, e.g., F⁻, Cl⁻, Br⁻, I⁻, NO₃⁻, N(CN)₂⁻, BF₄⁻, ClO₄⁻, PF₆⁻, (CF₃)₂PF₄⁻, (CF₃)₃PF₃⁻, (CF₃)₄PF₂⁻, (CF₃)₅PF⁻, (CF₃)₆P⁻, CF₃SO₃⁻, CF₃CF₂SO₃⁻, (CF₃SO₂)₂N⁻, (FSO₂)₂N⁻, CF₃CF₂(CF₃)₂CO⁻, (CF₃SO₂)₂CH⁻, (SF₅)₃C⁻, (CF₃SO₂)₃C⁻, CF₃(CF₂)₇SO₃⁻, CF₃CO₂⁻, CH₃CO₂⁻, SCN⁻, (CF₃CF₂SO₂)₂N⁻, etc.

The organic solvent may include, e.g., propylene carbonate (PC), ethylene carbonate (EC), diethyl carbonate (DEC), dimethyl carbonate (DMC), ethylmethyl carbonate (EMC), methylpropyl carbonate, dipropyl carbonate, dimethyl sulfoxide, acetonitrile, dimethoxy ethane, diethoxy ethane, vinylene carbonate, sulfolane, gamma-butyrolactone, propylene sulfite, tetrahydrofuran, etc. These may be used alone or in a combination of two or more therefrom.

In an embodiment, the secondary battery 10 may be an all-solid-state secondary battery. In this case, the anode, cathode and electrolyte may be properly changed or modified.

Electrode tabs (a cathode tab and an anode tab) may protrude from the cathode current collector 210 and the anode current collector 220 included in each electrode cell to one side of the pouch 100. The electrode tabs may be welded together with the one side of the pouch 100 to be connected to the first electrode tab 270 and the second electrode tab 275.

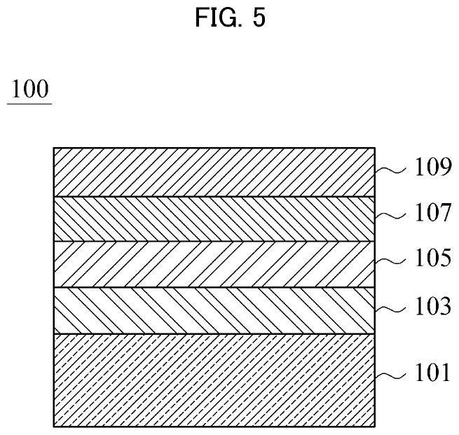

FIG. 5 is a cross-sectional view illustrating a laminated structure of a pouch of a secondary battery in accordance with exemplary embodiments.

Referring to FIG. 5, the pouch 100 may have a laminated structure including a sealant layer 101, a metal layer 105 and a coating layer 109. Additionally, a first adhesive layer 103 may be formed between the sealant layer 101 and the metal layer 105, and a second adhesive layer 107 may be formed between the metal layer 105 and the coating layer 109.

As described with reference to FIG. 1, after the electrode assembly 200 is accommodated in the first accommodating portion 131 or the second accommodating portion 133 of the pouch, the pouch may be folded along the folding portion 159 so that the first accommodating portion 131 and the second accommodating portion 133 may face each other. The sealant layers 101 may be bonded to each other by the sealing surface 151 of the edge of the peripheral portion 150 to seal the pouch.

For example, the sealant layer 101 may include a fusible material. In this case, the pouch may be sealed by a thermal fusion. The sealant layer 101 may include polyethylene, polypropylene, polycarbonate, polyethylene terephthalate, polyvinyl chloride, acrylic polymer, polyacrylonitrile, polyimide, polyamide, cellulose, aramid, nylon, polyester, polyparaphenylene benzobisoxazole, polyarylate, Teflon, a glass fiber, etc. The sealant layer 101 may have a single-layered structure or a multi-layered structure including two or more materials.

Preferably, the sealant layer 101 may include a laminate of homopolypropylene and modified polypropylene. For example, a total thickness of the sealant layer 101 may be in a range from about 60 μm to 100 μm, preferably from about 70 μm to 90 μm.

The metal layer 105 may prevent an external moisture, gas, etc. from penetrating into the electrode assembly, thereby improving a mechanical strength of the pouch, and may prevent a chemical substance injected into the pouch from being leaked to the outside.

For example, the metal layer 105 may include iron (Fe), chromium (Cr), manganese (Mn), nickel (Ni), aluminum (Al), an alloy thereof, etc., and may also include carbon. Preferably, the metal layer 105 includes aluminum (Al) and may have improved flexibility. A thickness of the metal layer 105 may be in a range from about 30 μm to 50 μm, preferably from about 35 μm to 45 μm.

The coating layer 109 may include nylon, and may include biaxially stretched nylon. For example, the coating layer 109 may have a thickness of about 10 μm to about 20 μm.

In an embodiment, the sealant layer 101, the metal layer 105 and the coating layer 109 may be attached to each other by the adhesive layers 103 and 107. For example, the adhesive layers 103 and 107 may have a thickness of about 3 μm or less. For example, the adhesive layers 103 and 107 may have a thickness of about 0.1 μm to 3 μm. In the thickness range of the adhesive layers 103 and 107, the adhesion of each layer may be improved while preventing an excessive thickness increase of the pouch.

Hereinafter, preferred embodiments are proposed to more concretely describe the present invention. However, the following examples are only given for illustrating the present invention and those skilled in the related art will obviously understand that various alterations and modifications are possible within the scope and spirit of the present invention. Such alterations and modifications are duly included in the appended claims.

### Examples and Comparative Examples

### (1) Fabrication of Electrode Cell

A cathode slurry having a mass ratio composition of 95:3:2 of LiNi_{0.8}Co_{0.1}Mn_{0.1}O₂ as a cathode active material, carbon black as a conductive material and polyvinylidene fluoride (PVDF) as a binder was prepared. The cathode slurry was coated, dried and pressed on an aluminum substrate to form a cathode.

An anode slurry was prepared using 92 wt % of artificial graphite as an anode active material, 2 wt % of a styrene-butadiene rubber (SBR)-based binder, 1 wt % of CMC as a thickener and 5 wt % of amorphous artificial graphite as a conductive material. The anode slurry was coated, dried and pressed on a copper substrate to form an anode.

An electrode assembly was prepared by disposing the prepared cathode and anode with a polyethylene (PE) separator (15 μm) interposed therebetween to form an electrode cell and winding the electrode cell.

### (2) Fabrication of Secondary Battery

A pouch (sealant layer: PP film 80 μm, metal layer: aluminum thin film 40 μm, coating layer: nylon film 15 μm) formed with an accommodating portion and a peripheral portion (a tab drawing portion and a side peripheral portion) was prepared. An insulation tape (PI tape, width 5 mm) was continuously attached to be parallel to a sealing surface along the tab drawing portion within 8 mm from an edge of the sealing surface (a boundary with a non-sealing surface). Thereafter, the electrode assembly was accommodated in the pouch, and then sealed by a fusion process under harsh conditions of 220° C. or more, a pressure of 0.7 MPa or more for 5 seconds or more using a sealing jig on the sealing surface.

Thereafter, a secondary battery was manufactured by injecting an electrolyte solution and then sealing. The electrolyte was prepared by preparing a 1 M LiPF₆ solution in a mixed solvent of EC/EMC/DEC (25/45/30; volume ratio) and then adding 0.5 wt % of 1,3-propanesultone (PS).

As shown in Table 1 below, lithium secondary batteries according to Examples and Comparative Examples were manufactured by changing the position of the insulation element or the sealing condition.

### Experimental Example

(1) Evaluation on Spot Welding

In the manufacturing process of the lithium secondary battery according to Examples and Comparative Examples, the generation of the spot welding in the pouch was evaluated as follows.

⊚: 5 or more spot weldings occurred.

◯: 3 to 5 spot weldings occurred.

Δ: 1 to 3 spot weldings occurred.

X: No spot weldings

### (2) Evaluation on Insulation Resistance

Using an insulation resistance meter, a resistance between the cathode or the anode and the pouch was measured. The battery was determined as a normal product when the measured resistance was 100 MΩ or more. According to the conditions of Examples and Comparative Examples, an average defect ratio during an operation of the lithium secondary battery production process was measured.

The evaluation results are shown in Table 1 below.

TABLE 1

| | | | | defect ratio of |
|---|---|---|---|---|
| | | sealing | generation | insulation |
| | | temperature | of spot | resistance |
| | Position of Insulation Tape | (° C.) | welding | (%) |
| Example 1 | inner surface of tap drawing portion of | 220 | Δ | ≤10 |
| | pouch upper side (lower side) | | | |
| Example 2 | inner surface of side peripheral portion of | 220 | ◯ | ≤30 |
| | pouch | | | |
| Example 3 | inner surfaces of tap drawing portions of | 220 | X | 0 |
| | pouch upper and lower sides | | | |
| Example 4 | inner surface of tap drawing portion of | 220 | Δ | ≤5 |
| | pouch upper side (lower side) + inner | | | |
| | surface of side peripheral portion of pouch | | | |
| Example 5 | inner surfaces of tap drawing portions of | 220 | X | 0 |
| | pouch upper and lower sides + inner | | | |
| | surface of side peripheral portion of pouch | | | |
| Example 6 | inner surfaces of tap drawing portions of | 230 | X | 0 |
| | pouch upper and lower sides + inner | | | |
| | surface of side peripheral portion of pouch | | | |
| Comparative | — | 220 | ⊚ | ≥75 |
| Example | | | | |

Referring to Table 1, in Examples where the insulation tape was attached along the inner surface of the sealing surface of the peripheral portion of the pouch, no spot welding occurred in the pouch, or three or less spot weldings occurred even under harsh sealing conditions. Additionally, the insulation resistance defect rate was also reduced. Further, when the insulation tape was attached to the inner surface of the pouch tab drawing portion, the effect of preventing the spot welding was enhanced.

In Example 6, the spot welding did not occur even when the sealing condition was strengthened.

In Comparative Example where the insulation tape was not attached to the peripheral portion of the pouch, the spot welding easily occurred.

In the above Examples, it was confirmed that the pouch adhesion risk could be reduced, and the insulation resistance property was also improved to enhance stability of the battery.

What is claimed is:

1. A secondary battery, comprising:
an electrode assembly;
a pouch accommodating the electrode assembly; and
an insulating element formed on an inner surface of the pouch,
wherein an inside of the pouch comprises an accommodating portion for inserting the electrode assembly and peripheral portions around the accommodating portion,
at least one of the peripheral portions has a sealing surface and a non-sealing surface, and
the insulating element is formed on the non-sealing surface and is not formed on the sealing surface.

2. The secondary battery of claim 1, wherein the insulating element is formed within 10 mm from a boundary between the sealing surface and the non-sealing surface.

3. The secondary battery of claim 1, wherein the insulating element is formed within 0.1 mm to 5 mm from a boundary between the sealing surface and the non-sealing surface.

4. The secondary battery of claim 1, further comprising an electrode tab connected to the electrode assembly and drawn to the peripheral portion of the pouch,
wherein the peripheral portions comprise a tab drawing portion through which the electrode tab is drawn out and a side peripheral portion from which the electrode tab is not drawn out.

5. The secondary battery of claim 4, wherein the insulating element is formed on at least a portion of an inner surface of the tab drawing portion and an inner surface of the side peripheral portion.

6. The secondary battery of claim 4, wherein the tab drawing portion is formed at upper and lower sides of the pouch, and the side peripheral portion is connected to the upper and lower sides.

7. The secondary battery of claim 4, wherein the tab drawing portion is formed at an upper side or a lower side of the pouch, and the side peripheral portion is connected to the upper side or the lower side.

8. The secondary battery of claim 4, wherein the accommodating portion comprises a first accommodating portion and a second accommodating portion facing each other, and
the peripheral portions further comprise a folding portion separating the first accommodating portion and the second accommodating portion.

9. The secondary battery of claim 8, wherein the insulating element is not formed on an inner surface of the folding portion.

10. The secondary battery of claim 1, wherein the insulating element comprises an insulating tape including at least one selected from the group consisting of polyethylene, polyacetylene, polytetrafluoroethylene, nylon, polyimide, polyethylene terephthalate, polypropylene and chlorinated polypropylene.

11. The secondary battery of claim 1, wherein the pouch has a laminated structure including a sealant layer, a metal layer and a coating layer.

12. The secondary battery of claim 11, wherein the sealant layer includes a polyolefin-based resin, the metal layer includes aluminum, and the coating layer includes nylon.
